(19) United States
(12) Patent Application Publication
(10) Pub. No.: US 2014/0282948 A1
(43) Pub. Date: Sep. 18, 2014

(54) SIGNAL PROCESSING METHOD FOR USE IN ASSOCIATION WITH ELECTRONICALLY CREATED PASSWORDS

(71) Applicant: Mark Rodney Anson, Sydney (AU)

(72) Inventor: Mark Rodney Anson, Sydney (AU)

(21) Appl. No.: 14/207,083

(22) Filed: Mar. 12, 2014

Related U.S. Application Data
(60) Provisional application No. 61/809,357, filed on Apr. 6, 2013.

(30) Foreign Application Priority Data
Mar. 12, 2013 (AU) 2013900837
Jun. 25, 2013 (AU) 2013100873

(51) Int. Cl. G06F 21/46

(52) U.S. Cl. CPC G06F 21/46
USPC 726/6

(57) ABSTRACT

A method for automatically transforming elements of a user generated signal that defines a password, using software encoded on a computer readable medium, in such a way that a transformed signal is produced that is difficult to guess using trial and error methods.

### CROSS REFERENCE TO RELATED APPLICATIONS

This application claims priority to (a) Australian Provisional Patent Application, No. 2013900837, entitled “A Signal Processing Method for Use in Association with Electronically Created Passwords”; (b) Australian Innovation Patent Application, No. 2013100873, entitled “A Signal Processing Method for Use in Association with Electronically Created Passwords”; and (c) U.S. Provisional Patent Application, No. 61/809,357, entitled “A Signal Processing Method for Use in Association with Electronically Created Passwords”; all three of which are hereby incorporated by reference as though fully set forth herein.

### BACKGROUND OF INVENTION

1. Technical Field

The present invention pertains to the field of signal processing.

2. Background Art

Signals both analogue and digital have a long history of use for transmission of passwords to prevent unauthorized access to electronic systems.

### SUMMARY OF INVENTION

Central to the inventor's contribution is the discovery of the following problems by the inventor:

General problems with background art: electronically encoded passwords that are user generated and transmitted across communication networks are inherently vulnerable to attack by unauthorised persons.

Specific problems with background art identified by the inventor: electronically defined passwords are often easily guessed.

Further, problems and solutions identified by the inventor include:

insufficient length of character sets—character sets carried (defined) by an electronic signal should preferably be at least 8 characters in length;

insufficient balance between upper case and lower case letters in alphabetic character sets;

insufficient use of characters defining numbers and control characters (non-alphanumeric characters);

the expression ‘insufficient’ means that an electronic signal is created that defines data that has, according to a predetermined probability distribution, a high probability of being generated either at random or by a plurality of methods including use of look-up tables and other standardized methods for decrypting passwords.

The above difficulties pertain not only to languages that are predominately encoded phonetically, including English but also pertain to languages where pictographic representations of a word are more common, for example the Japanese language's use of kanji characters; in the latter case the use of pictographic representations for words which are highly common (when considered on the basis of a probability distribution) are to be avoided, for example even when Japanese characters are encoded using bitmap, as one form of encoding, and ultimately encoded in binary form, it is the use of a ‘common’ binary encoding for characters, measured against a pre-determined standard of what is considered ‘common’ that is to be avoided.

### Technical Problem

To ameliorate some of the effects of the general problems and the specific problems as recited above.

### Technical Solution

Automatically transforming elements of an electronically parsed signal (the signal having been user generated), by use of a computer, into a plurality of different elements in such a way that a resultant signal defines a strong password.

### Advantageous Effects

Advantageous effects include: increased security of electronic systems and associated reduction in fraudulent practises by unauthorized persons seeking to gain access to electronic systems.

A method for automatically transforming elements of a user generated signal that defines a password, using software encoded on a computer readable medium, in such a way that a transformed signal is produced that is difficult to guess using trial and error methods (with respect to a predetermined probability distribution).

### BRIEF DESCRIPTION OF DRAWINGS

FIG. 1 discloses a preferred embodiment of invention for transformation of a signal from one form to another.

FIG. 2 discloses use of an embodiment of the present invention in the context of mobile phone usage.

FIGS. 3-7 show preferred embodiments of the invention, in use, in association with a smartphone display screen.

### DETAILED DESCRIPTION

### Definitions and Terms

The description in the body of the specification pertains to ‘preferred’ modes of invention. Accordingly, features recited in the body should not be construed to be essential features of the invention unless explicitly indicated. Further, any reference in the body to the expression ‘invention’ should be construed to imply a reference to preferred embodiments only.

FIG. 1 discloses, according to one embodiment, a signal in machine-readable form that defines a set of characters. The signal can be in analogue or digital form.

Information carried by signal 10 is shown in abstracted form as string 12. Each of the elements of string 12 (elements 18-22) is seen to define alphabetical characters a, b and c.

Upon transmission of the signal 10 by a user of a communications device to a computer (local or remote), the computer, acting under instructions provided by software, then interrogates the signal 10. The signal 10, after parsing (breaking the signal up into the signal's three components in the preferred embodiment), is then determined to contain a plurality of defects, in so far as information conveyed by signal 10 is concerned, including: insufficient number of characters defined by the signal; absence of upper case alphabetical characters; absence of numerical characters and control characters (non alphanumeric characters).

The string 12 can then be automatically replaced by string 14, using a computer. String 14 contains characters 24-38, the latter characters selected in such a way that the probability, according to a predetermined probability distribution, of guessing the contents of string 14 (as opposed to string 12) is now sufficiently low, so that string 14 can be characterized as defining a “strong” password.

According to one preferred embodiment, details of the transformation of string 12 into string 14 are as follows. Character ‘a’ is transformed into lower case character ‘z’ (at position 24). Character ‘b’ is transformed into upper case ‘K’ (at 26) and character ‘c’ is transformed into a dollar symbol ‘$’ (at 28). Additional characters are then added in the form of an upper case ‘X’ (at position 30), the caret character ‘̂’ (at position 32), the number ‘7’ (at position 34), the number ‘2’ (at position 36) and the symbol ‘@’ (at position 38). In summary, characters 18-22 have been replaced with characters 24-18 and characters 30-38 have been added. The characters, at positions 18-38 (in strings 12 and 14), can be defined according to any character format including ASCII coding formats in decimal, hexadecimal and 7-bit binary renditions. Further, while one preferred embodiment above denotes sequential, character by character correspondence (between characters in string 12 and those in string 14), characters in string 14 can, in another embodiment, be randomized to reduce the likelihood of string 14 being guessed by an unauthorized person.

Once string 14 has been constructed, string 14 can then be used to transform signal (waveform) 10 into signal (waveform) 16 (waveform 16 can be implemented in digital or analogue format). Each of the three elements in signal 10 is then replaced by three elements in signal 16 and an additional 5 elements, corresponding to elements 30 to 38.

The transformed signal (electromagnetic waveform in either digital or analogue form) can then be sent to the user across a communication system.

The entire process recited above can occur automatically by a computer operating under instructions provided by a computer program (software). The process of transmission and reception of signals to and from a user continues iteratively until both the user and the computer agree upon a character set that is acceptable to the user and also satisfies objective criteria of defining a password that is difficult to determine by trial and error methods.

In executing the above operations, further layers of encryption can be contemplated. For even if the user accepts string 14 (as further defined by signal 16); the string can be further encrypted prior to being saved on a computer readable medium.

FIG. 2 displays the password transformation processes recited above in use. A user is seen holding a portable communication device 40. The user then sends a proposed password in the form of an electromagnetic signal (propagated signal) to a server 44. The server 44, in this instance, automatically analyses and can classify the signal as defining a weak password. In the latter case, the server 44 then sends a revised password, being a strong password 46, back to the user's portable communication device for approval by the user. The loop of iteration continues until the user approves a password suggested by the server.

In use below, an embodiment of the present invention is presented in which various control characters (non-alphanumeric characters) are used to satisfy the desired notion of transforming signals into a form that defines strong passwords.

### INDUSTRIAL APPLICABILITY

Logging onto an Internet site with a portable communication device including a smartphone or similar device frequently involves the submission of a form containing a username or user-id together with a password or pass phrase. The use of strong passwords on smartphones can be cumbersome for users with the result that some users choose to use short length, ineffective, unsafe passwords that they can remember easily.

Further, passwords of users of mobile phones must be formed from characters in character sets available on keyboards of mobile devices. An efficient system for the creation of strong passwords from these kinds of limited character sets can provide a high degree of security for users and web site owners. One embodiment that enables character substitution to produce strong passwords will be recited below:

### Step 1

An application server or Internet website sends data to a user accessing the site with a mobile phone, tablet or similar device, and when the user receives this data the user can see a form displayed on his/her smartphone accompanied by a message “enter a password or phrase of not less than 8 characters”.

### Step 2

The user enters a phrase into the form such as “Rob the builder”.

### Step 3

The user clicks a “submit” or “save” button on the form, or through another means they submit the form, and this action sends data back to the web site.

### Step 4

The web site server receives this data and begins a series of processes. The first process would be to see if the phrase entered by the user is suitable for use as a password, by checking to see if the password or phrase is within a list of most commonly used passwords (and as such rejected). Lists of the 100 most commonly used passwords, 1,000 most common, and 10,000 most common passwords are routinely available and a password included in these types of lists would be deemed not be acceptable for use. Additionally, other words and phrases such as a password or phrase that was previously used by the user could preferably be rejected. If the password entered by the user is rejected then the web server could send a message back to the user asking the user to change his\her input and to create a phrase that would make a sufficiently strong password (together with hints as to what steps could be taken to define a strong password). The server could also suggest at least one alternative password to the user, the suggestion being based upon character substitution (details of this operation are recited below). The user would then resubmit his\her input and the web site software, after receiving the input, could begin to process the password again and so determine whether or not the password suggested by the user meets objective criteria of being sufficiently strong.

When the password entered by a user is received by the web site, additional software functioning within the site can take the password submitted in the form of an electronic signal by the user and begin to transform the password after the signal has been parsed. The web site software can produce a strong password from the phrase “Rob the builder” while at the same time keeping the phrase recognizable and memorable, as for example when the phrase “rob the builder” could be transformed into “roB th3*bui!)e4”. Parsing by definition will result in the signal being broken into smaller chunks (elements). Individual elements can then be subject to replacement so that a composite signal can be generated in such a way that the probability of guessing the signal by methods including: using lookup tables of common passwords or by way of random guessing, will be sufficiently small to classify the transformed (processed) signal as defining a strong password.

A number of operations can be employed in producing this transformation. Numbers or non-alphanumeric symbols could be suggested on the basis of similarity in appearance or sound, for example a ‘3’ could be used as a replacement for “e” based upon “some” limited similarity in appearance or in based upon sound when the number ‘3’ and the letter ‘e’ are read out aloud; in another example the exclamation mark! could be used in place of the letter l, or right parentheses mark ‘)’ could used as a replacement for the character d. Lower case letters could be replaced by uppercase letters at random, for example in the resultant word “roB” to replace ‘Rob’. Spaces in the pass phrases can also be replaced at random with a symbol selected from the following characters as #, %, *, / to replace the space in one embodiment.

As a general principle, passwords generated by the web site software should preferably be at least eight characters in length (however, other preferred predetermined lengths can be contemplated) and should have two lowercase characters, two uppercase, two numbers and two control characters (non-alphanumeric characters). However, other numbers (quantities) of lower case characters, upper case characters, control characters and numerals can also be used in differing embodiments. Variations on this theme can be contemplated, because of allowance for unusual combinations of characters submitted by a user, for example “40B d@ builder” is likely to be judged a strong password. An acceptable password should always contain at least one control character, a number, one uppercase and one lowercase alphabetical character.

### Step 5

The web site can send an electronically transformed signal back to the mobile phone of the user so that the data defined by the signal is displayed again in a form field. The user can see the text “boB th3*bui!)e4” in the form field along with a submit button saying “save”. The user can choose to edit the text in some new way, for example, he\she can opt to change the text to “roB=th3=bui!)e4” to make the text more memorable. The user can then click the “save” button and send the form data back to the web server.

### Step 6

The web site then receives the electronic signal containing data submitted in the form. Software on the web site can examine the signal transmitted by the user and checks to see if the signal's pass phrase defines a sufficiently strong password. If not, the web server can send a signal back to the user containing a message that asks the user to modify the password to make a sufficiently strong password. This process of parsing, altering elements of the contained signal (by way of substitution of other signal elements), transmitting and receiving modified signals is repeated until the user receives a signal that is classified as being strong (having a sufficiently low probability of being interrogated against electronically stored look up tables or being guessed at random) and which defines a password that the user is prepared to accept.

When an electromagnetic signal defining a final strong password is transmitted by a user to a computer (remote or local), the user is then sent an electronic signal by the computer with a message stating that the data he\she has input is accepted as a password. The password can be displayed to the user on the screen of their portable communication device (that can include a smartphone) and the user can be requested to write down this password and keep the password in a secure location.

### Step 7

The web server can electronically encode and save a record of this new password by saving the password in such a way that the password can enable the user to log in or access secure electronically stored content provided by a web site operated by the server. It is recommended that the password itself should not be saved in the web site's electronic database but rather that a method such as the use of a secure hash algorithm like SHA-2 can be used to produce resultant data that is saved in a database and ultimately used for facilitating the login of users of the web site operated under control of the server. Further, to the above all data transmitted across communication lines can be further secured by way of symmetric and asymmetric encryption as well as by way of use of key sharing arrangements to access secure content such as the Diffie Hellman key sharing algorithms.

FIGS. 3-7 demonstrate the use of the above processes in use, in further detail.

FIG. 3 shows the broad schematic layout of certain components of an electronic system used to perform the above processes. A web server is located at position 48. Communications to and from the server 48 operate according to a secure transmission protocol SSL/HTTPS. 50. The server 48 is connected to the Internet shown at position 52. The Internet 52 interacts through the SSL/HTTPS protocol 54 with a smartphone or tablet 56.

FIG. 4 shows the visual result of the above operations as seen by a user. The web server 48 (as seen in FIG. 3) sends HTML form data to the smartphone (seen at 56 in FIG. 3). The smartphone receives data and displays the HTML form as seen at 58 in FIG. 4. Characters at position 60 are available for password entry by the user.

FIG. 5 shows the result of password entry by a user into field 62. The user can then click the save button 64 and submit the HTML form. The form data can then be sent back to the server as an electronically generated signal.

FIG. 6 shows the result of transformation of the signal processing operations recited above. In particular the web server receives the signal carrying the password previously submitted by the user. The software parses the password phrase (string) as defined by the signal and then transforms the signal received by the server to produce a new signal that is resent to the user. The new signal contains the new password shown in the field at position 62. The user can then accept this new password and click the save button 64. The form data can then be sent back the server.

FIG. 7 shows the results of the user accepting the transformed password. The web server receives the form data. The computer (server) under control of software, can then check the password phrase. The server can confirm that the password finally accepted by the user is strong. The server can the save the password or in a preferred embodiment, further encode and encrypt the password (for localized decryption by the server). The web server can then send a confirmation message to the user. The user can then see the pass phrase on his/her smartphone and a message saying please save this password”.

What is claimed is:

1. A method comprising a step of: transforming an electronic signal defining a user generated password, in such a way that a resultant transformed signal defines a transformed password, where the transformed password has a predetermined probability of being generated at random.

2. The method as recited in claim 1, further comprising a step of: transforming the electronic signal in such a way as to ensure that the transformed password is of a predetermined length.

3. The method as recited in claim 2, further comprising a step of: transforming the electronic signal in such a way as to ensure that there is at least one lower case alphabetical character and at least one upper case alphabetical character in the transformed password.

4. The method as recited in claim 3, further comprising a step of: transforming the electronic signal in such a way as to ensure that there is at least one number in the transformed password.

5. The method as recited in claim 4, further comprising a step of: transforming the electronic signal in such a way as to ensure that there is at least one control character in the transformed password.

6. The method as recited in claim 5, further comprising a step of: transforming the electronic signal in such a way as to ensure that characters in the transformed password are randomized.

7. The method as recited in claim 6, further comprising a step of: transforming the electronic signal in such a way as to ensure that additional characters are added to the transformed password.
